(19) United States
(12) Patent Application Publication
(10) Pub. No.: US 2022/0291352 A1
(43) Pub. Date: Sep. 15, 2022

(54) OPTICAL SCANNERS WITH ADJUSTABLE SCAN REGIONS

(71) Applicant: HEWLETT-PACKARD DEVELOPMENT COMPANY, L.P., Spring, TX (US)

(72) Inventors: Yow Wei CHENG, Taipei City (CN); Chia-Wei TING, Taipei City (CN)

(21) Appl. No.: 17/638,360

(22) PCT Filed: Oct. 14, 2019
(86) PCT No.: PCT/US2019/056084

§ 371 Date: Feb. 25, 2022

(51) Int. Cl. G01S 7/481; G01S 7/497; G01S 7/48

(52) U.S. Cl. CPC G01S 7/4817; G01S 7/4972; G01S 7/4808

(57) ABSTRACT

An example scanner includes: a base defining a platform surface to support an object, the platform surface having a center and a normal axis extending from the center; a plurality of imaging assemblies, each including (i) a camera mount; and (ii) an arm carrying the camera mount, the arm being movably coupled to the base to place the camera mount at an adjustable distance from the normal axis; and a plurality of cameras supported by corresponding ones of the camera mounts to define a scan region over the platform surface, the scan region having an adjustable volume according to the distances between the camera mounts and the normal axis.

### BACKGROUND

Optical scanners can be used to obtain digital three-dimensional representations of various objects. The sizes and shapes of such objects, and the operational requirements imposed on the scanner, can vary.

### BRIEF DESCRIPTIONS OF THE DRAWINGS

FIG. 1 is a diagram of an example optical scanner with an adjustable scan region.

FIG. 2 is another diagram of the scanner of FIG. 1, with arms thereof adjusted to reduce the volume of a scan region.

FIG. 3 is a further diagram of the scanner of FIG. 1, with the arms thereof further adjusted to change the volume and shape of the scan region.

FIG. 4 is a diagram illustrating a side view of certain components of a scanner, including a mechanical linkage enabling adjustment of camera angle in response to adjustment of arm position.

FIG. 5 is a diagram of the arrangement shown in FIG. 4 in which the position of the arm has been adjusted, showing a corresponding adjustment to a camera angle via the mechanical linkage.

FIG. 6 is a diagram of another example optical scanner with an adjustable scan region, including guide features.

FIG. 7 is a flowchart of a method of operation of an optical scanner with an adjustable scan region.

FIG. 8 is a flowchart of a method for performing block 705 of the method of FIG. 7.

FIG. 9 is a flowchart of a camera position evaluation performed during the performance of the method of FIG. 7.

FIG. 10 is a diagram of example camera positions evaluated in the performance of the flowchart of FIG. 9.

### DETAILED DESCRIPTION

Optical scanners employ a set of cameras or other sensors (e.g., laser scanners) with overlapping fields of view (e.g. stereoscopic pairs of sensors) to capture a three-dimensional representation of an object in a scan region. A variety of objects can be scanned using such devices, such as packages (e.g., in shipping and logistics facilities), feet (e.g., for the purpose of shoe sizing and manufacturing), and the like. The extent of the scan region, which is a volume within which an object can be accurately scanned to generate a three-dimensional representation thereof, depends on the positioning and extent of the fields of view of the sensors. For example, the scan region may be a volume in which any point is visible by at least two sensors. An optical scanner may therefore only be able to accommodate objects that do not exceed the extents of the scan region dictated by the arrangement of the scanner's sensors.

Accommodating larger objects may be accomplished by a larger scanner, with more widely-spaced sensors. However, the larger scanner may suffer from reduced accuracy over at least a portion of the scan region. Further, the larger scanner may have a larger footprint, thus requiring more space to store and deploy, and may also be more costly to manufacture, as a result.

To provide more accurate scanning for at least certain objects (e.g., objects requiring smaller scan regions), while also providing the ability to accommodate larger objects without permanently increasing the size of the optical scanner, the sensors of an optical scanner of examples disclosed herein are mounted movably relative to a base of the optical scanner. The movably mounted sensors permit the size and/or shape of the scan region to be reconfigured according to the size of the object to be scanned.

In the examples, the scanner comprises a base defining a platform surface to support an object, the platform surface having a center and a normal axis extending from the center; a plurality of imaging assemblies, each including (i) a camera mount; and (ii) an arm carrying the camera mount, the arm being movably coupled to the base to place the camera mount at an adjustable distance from the normal axis; and a plurality of cameras supported by corresponding ones of the camera mounts to define a scan region over the platform surface, the scan region having an adjustable volume according to the distances between the camera mounts and the normal axis.

The camera mounts can rotatably support the cameras at adjustable angles relative to the platform surface.

Each camera mount can adjust the angle of the corresponding camera in response to movement of the corresponding arm to adjust the distance between the camera mount and the normal axis.

Each imaging assembly can further comprise a mechanical linkage between the base and the camera mount, to adjust the angle of the corresponding camera responsive to adjustment of the distance between the camera mount and the normal axis.

Each imaging assembly can include an emitter to project light onto the platform surface to indicate boundaries for a portion of the scan region.

Each arm can include a set of distance indicators on an arm surface.

The arms can be independently movable relative to the base.

Each imaging assembly can include a sensor to detect movement of the corresponding arm relative to the base.

In some examples, the scanner comprises a platform to support an object to be scanned; a plurality of cameras supported at adjustable positions about a perimeter of the platform to define a scan region having an adjustable volume according to the positions of the cameras; and a controller connected with the cameras to: generate calibration data defining the relative positions of the cameras; control the cameras to capture a set of images of the object; and generate a three-dimensional representation of the object based on the set of images and the calibration data.

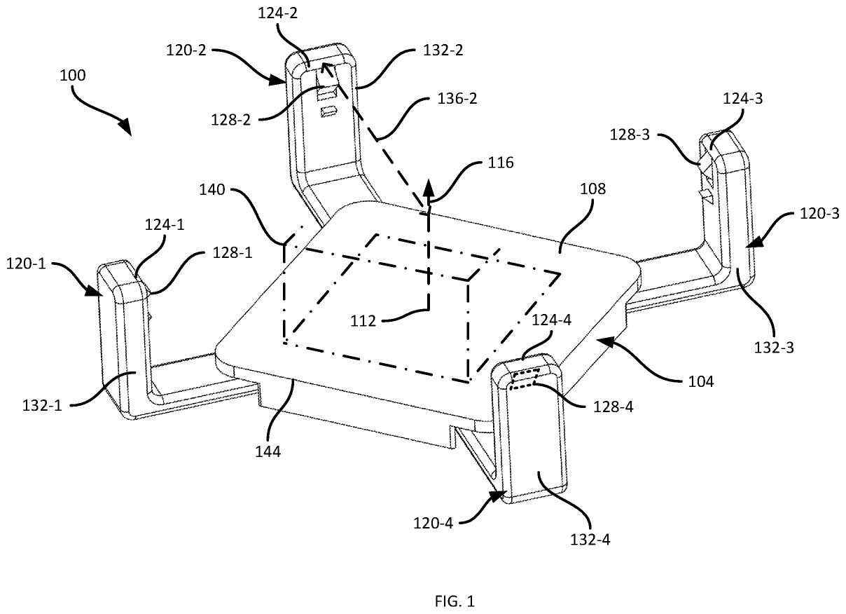

FIG. 1 shows an example optical scanner 100 (also referred to herein simply as the scanner 100) with an adjustable scan volume. The scanner 100 includes a base 104 defining a platform 108. The platform 108, in the present example, is a planar upper surface of the base 104, and may therefore also be referred to as the platform surface 108. The platform 108 is referred to as an upper surface of the base 104 because when the scanner 100 is deployed for use, the scanner 100 rests on a support surface such as the ground, a table or the like, and the platform 108 faces upwards, away from the support surface.

The platform 108 supports an object to be scanned (not shown in FIG. 1), as will be discussed in greater detail below. The platform 108, as noted above, is a planar surface in the present example, with a center 112 from which a normal axis 116 extends. The normal axis is perpendicular to the platform 108, and thus in the present example is a vertical axis when the scanner 100 is deployed for use (with the platform 108 providing a horizontal support for the object mentioned above).

The scanner 100 also includes a plurality of imaging assemblies, of which four examples 120-1, 120-2, 120-3 and 120-4 are shown in FIG. 1 (collectively referred to as the imaging assemblies 120, and generically referred to as an imaging assembly 120; similar nomenclature is also used for other elements described herein). In other examples, different numbers of imaging assemblies 120 may be provided. For example, the scanner 100 can include as few as two imaging assemblies 120 in some examples, and may include more than four imaging assemblies 120 in other examples.

Each imaging assembly 120 includes a camera mount 124. Thus, four camera mounts 124-1, 124-2, 124-3 and 124-4 are shown in FIG. 1. The camera mounts include suitable structural components to support respective cameras 128-1, 128-2, 128-3 and 128-4. Each imaging assembly 120 also includes an arm 132 carrying the corresponding camera mount 124. The scanner 100 as shown in FIG. 1 therefore includes four arms 132-1, 132-2, 132-3 and 132-4. In the present example, the camera mounts 124 are formed integrally with the arms 132, in that the camera mounts are recesses defined in the arms 132 near the ends of the arms 132. The camera mounts 124 can include any other suitable combination of components to support the cameras 128, however, including brackets, adhesives and the like.

Each of the arms 132 is movably coupled to the base 104, to place the corresponding camera mount 124 (and by extension, the camera 128 supported by that camera mount 124) at an adjustable distance from the normal axis 116. Distances from the normal axis 116 as referred to herein are measured perpendicular to the normal axis 116. An example distance 136-2 between the normal axis 116 and the camera mount 124-2 is illustrated in FIG. 1. The distance 136-2, and corresponding distances between the other camera mounts 124 and the normal axis 116, can be increased or decreased via movement of the arms relative to the base 104. When the distances 136 are increased, the volume of a scan region 140 (illustrated only partially in FIG. 1 to avoid obstructing other illustrated elements) increases, and when the distances 136 are decreased, the volume of the scan region 140 decreases. In other words, the cameras 128 are supported by respective ones of the arms 132 and camera mounts 124, at adjustable positions about a perimeter 144 of the platform 108 (that is, an outer edge of the platform 108).

The scan region 140, as noted earlier, is a volume of space in which objects can be accurately scanned by the cameras 128 (e.g., because each point within the scan region 140 is visible by a minimum number of cameras 128, e.g., two). Although the scan region 140 is illustrated as a rectangular prism in the present example, the scan region 140 need not have a rectangular shape. The shape of the scan region 140 also need not remain consistent as the positions of the arms 132 are adjusted. In some examples, the arms 132 can be adjusted independently of one another, and the scan region 140 can therefore be elongated or shortened in a given direction more or less than in another direction.

In the present example, the arms 132 are substantially right-angled members having proximal portions movably coupled to the base 104, and distal portions carrying the camera mounts 124. As seen in FIG. 1, the proximal portions are substantially parallel with the platform 108, and thus are substantially horizontal when the scanner 100 is deployed for use. The distal portions are substantially perpendicular to the proximal portions. A wide variety of other configurations may be employed for the arms 132, however. For example, rather than an elbow-shaped member as shown in FIG. 1, the arms 132 can extend from the base 104 at an incline (i.e. an angle between horizontal and vertical). Further, the arms 132 need not all have the same construction.

The arms 132 are movable relative to the base 104 by sliding the proximal portions thereof into or out of the base 104. The arms may be slidably coupled to the base by any suitable mechanism, such as by friction fit, piston mounts, or the like. Movement of the arms 132 may be caused by an operator of the scanner 100, e.g., by grasping an arm 132 and moving the arm 132 to the desired position.

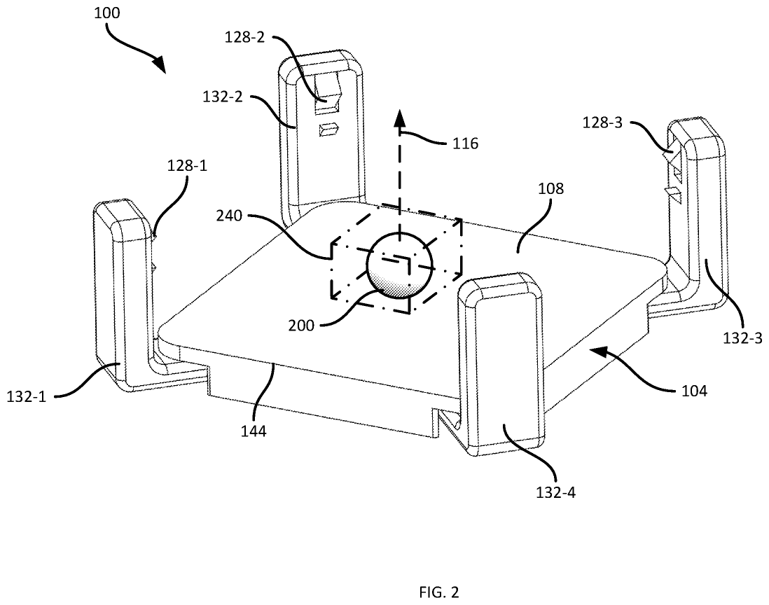

Turning to FIG. 2, the scanner 100 is shown in another configuration, in which each of the arms 132 has been adjusted relative to the base 104 to reduce the distances between the cameras 128 and the normal axis 116. The scan region 140 has been reconfigured, as a result of the repositioning of the arms 132 and the resulting repositioning of the cameras 128 about the perimeter 144 of the platform 108, to a scan region 240. The scan region 240 has a smaller volume than the scan region 140 of FIG. 1, and may be employed to scan an object such as the ball 200, which does not require the use of the larger scan region 140. A wide variety of objects may be scanned by the scanner 100, including for example, packages, body parts (e.g., feet) and the like.

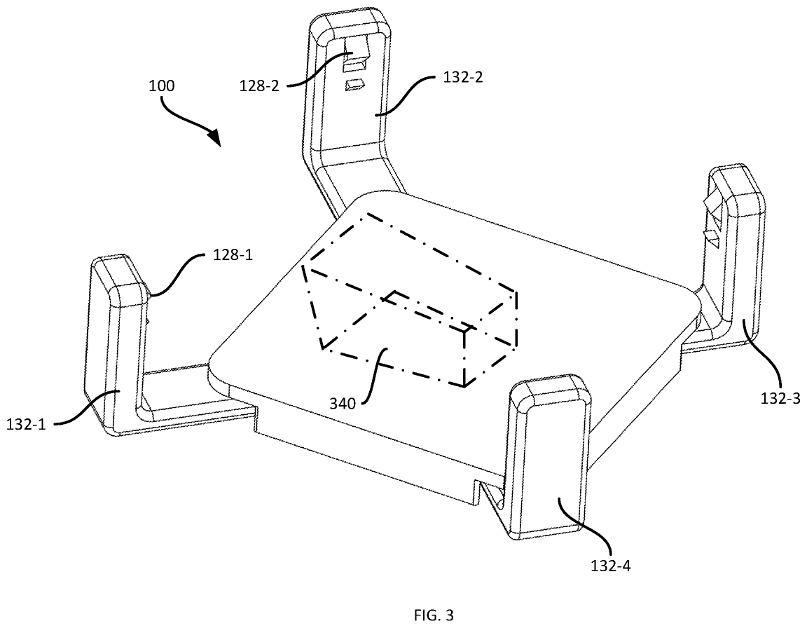

Turning to FIG. 3, another example configuration of the scanner 100 is shown, illustrating independent adjustability of the arms 132. In particular, the arms 132-1 and 132-2 have been adjusted to increase the distance between the normal axis 116 and the cameras 128-1 and 128-2, while the positions of the arms 132-3 and 132-4 are unchanged from their positions as illustrated in FIG. 2. The configuration shown in FIG. 3 defines a scan region 340, which is no longer a rectangular prism, but rather expands towards the cameras 128-1 and 128-2.

In addition to supporting the cameras 128 at adjustable positions relative to the platform 108, the camera mounts 124 can, in some examples, rotatably support the cameras 128 at adjustable angles relative to the platform 108. For example, the recesses of the camera mounts 124 mentioned above can support the cameras 128 on pins about which the cameras 128 can rotate. Various other support mechanisms permitting rotation of the cameras may also be employed.

In some examples, the rotation of the cameras 128 may be manual. That is, the operator of the scanner 100 may position each arm 132, and then may also adjust the position of each camera 128. In other examples, however, the camera mounts 124 adjust the angles of the corresponding cameras 128 in response to movement of the corresponding arms 132.

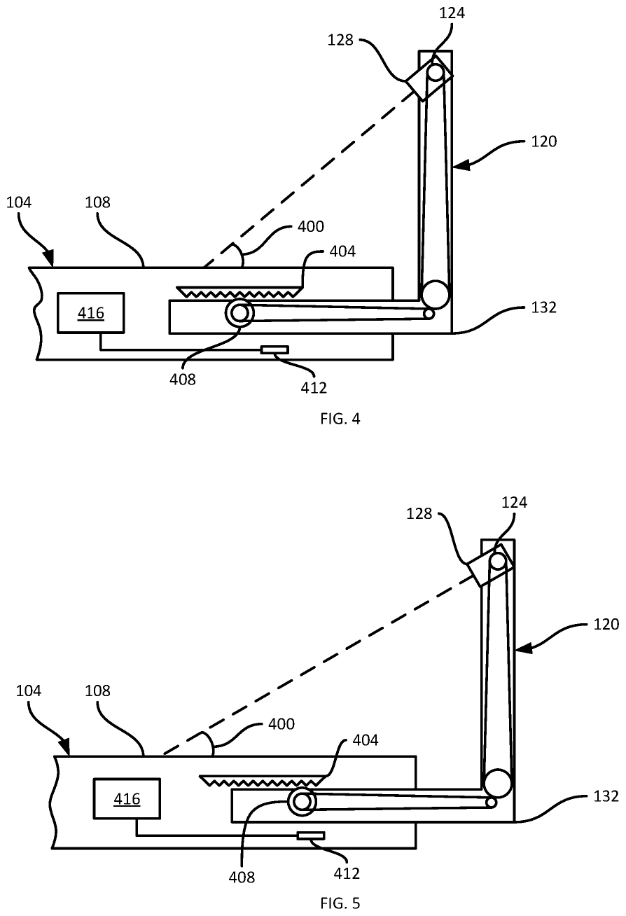

Turning to FIGS. 4 and 5, side-view diagrams of an imaging assembly 120 in which the camera mount 124 adjusts an angle 400 between the camera 128 (more specifically, an angle between an optical axis of the camera 128) and the platform 108 in response to movement of the arm 132 relative to the base 104. In particular, the imaging assembly 120 includes a mechanical linkage between the base 104 and the camera mount 124 to achieve the above-mentioned angular adjustment of the camera 124.

The mechanical linkage includes, in the illustrated example, a member disposed on or in the base 104, such as a rack 404 illustrated in FIG. 4. The rack 404 is positioned within the base 104 adjacent to the arm 132. The arm 132 includes a first pulley 408 (e.g., a toothed gear) that engages with the rack 404 to rotate as the arm 132 moves into or out of the base 104. The first pulley 408, in turn, drives one or more additional pulleys, for example via belt drives, gear trains or the like, to drive rotation of the camera mount 124. As shown in FIGS. 4 and 5, movement of the arm 132 to increase the distance between the camera mount 124 and the normal axis 116 decreases the angle 400. In particular, the angle 400 as shown in FIG. 5, when the arm 132 has been repositioned to place the camera 124 further from the platform 108, is smaller than the angle 400 as shown in FIG. 4.

The mechanical linkage and the camera mount 124, in other words, incline the camera 128 upwards as the arm 132 is withdrawn from the base 104, and incline the camera 128 downwards as the arm 132 is inserted into the base 104. The magnitude of angular adjustments of the cameras 128 responsive to movement of the arms 132 can be selected based on attributes of the platform 108 and the cameras 128 (e.g., based on extents of the fields of view of the cameras 128).

In other examples, the mechanical linkage shown in FIGS. 4 and 5 can be implemented with components other than those shown in the drawings, such as a motor to rotate the camera mount 124 in response to a signal indicating movement of the arm 132.

The scanner 100 can also include a sensor 412 (e.g., a proximity sensor, an optical sensor, or the like) connected to a controller 416, such as a microcontroller supported within the base 104. The controller 416 can determine, based on signals received from the sensor 412, whether the arm 132 is in motion or has ceased moving. The sensor 412, in other words, detects movement of the arm 132 relative to the base 104. The scanner 100 can include one such sensor 412 for each imaging assembly 120. The controller 416, in response to detecting that the arms 132 are stationary, can initiate a calibration process to detect the configuration of the scan region in preparation for object scanning.

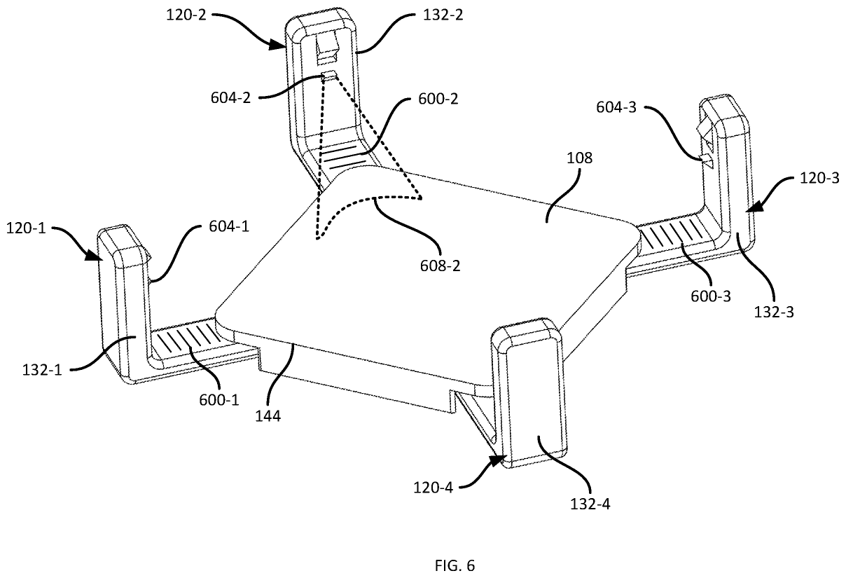

Turning to FIG. 6, in some examples the scanner 100 can include further features to guide an operator in the adjustment of the imaging assemblies 120. For example, each arm 132 can include a set of distance indicators 600 (three examples 600-1, 600-2 and 600-3 are visible in FIG. 6). The distance indicators 600 can be embossed on the arms 132, engraved on the arms 132, printed on the arms 132, or the like. The position of an arm 132 can be assessed objectively based on which ones of a given set of distance indicators 600 are visible beyond the perimeter 144 of the platform 108.

The scanner 100 can also include, in addition to or instead of the distance indicators 600, an emitter 604 (three examples of which, 604-1, 604-2 and 604-3, are visible in FIG. 6). The emitter 604 can be supported on the corresponding arm 132, for example adjacent to the camera mount 124. The emitter can include one or more light emitting diodes (LEDs) or other light emitters, to project a predefined pattern 608 of light onto the platform 108. An example pattern 608-2 is shown in FIG. 6, and the remaining emitters 604 may also emit corresponding patterns, which may have the same or different shapes as the pattern 608. The patterns 608 serve as guides for the placement of an object to be scanned on the scanner 100. For example, the patterns 608 can indicate boundaries for a portion of the scan region of the scanner 100. The portion of the scan region indicated by the patterns 608 can be smaller than the complete scan region.

The pattern 608 can be produced via the application of a mask to the emitter 604, and can be selected based on attributes of the corresponding camera 128, the expected shape of objects to be scanned, or the like. When the arms 132 are adjusted, the shape and/or size of the pattern 608 on the platform 108 also changes.

In some examples, operation of the scanner 100 includes the execution of a method comprising: at a controller of a scanner having adjustably positioned cameras defining an adjustable scan region over a platform surface, detecting an indication that positioning of the cameras for scanning is complete; responsive to the detection, performing a calibration process at the controller; receive, at the controller, a command to scan an object on the platform surface; and controlling the cameras to capture images of the object.

Detecting the indication can include receiving a command to perform the calibration process.

Detecting the indication can include detecting that a period of time has elapsed without movement of adjustable arms carrying the cameras.

The method can include, in response to completing the calibration, enabling an emitter to project light on the platform surface.

The method can include, responsive to the detection, determining whether the positioning of the cameras satisfies a predefined criterion; and when the positioning of the cameras does not satisfy the predefined criterion, generating an error message.

The predefined criterion can be that positions of the cameras form a convex polygon.

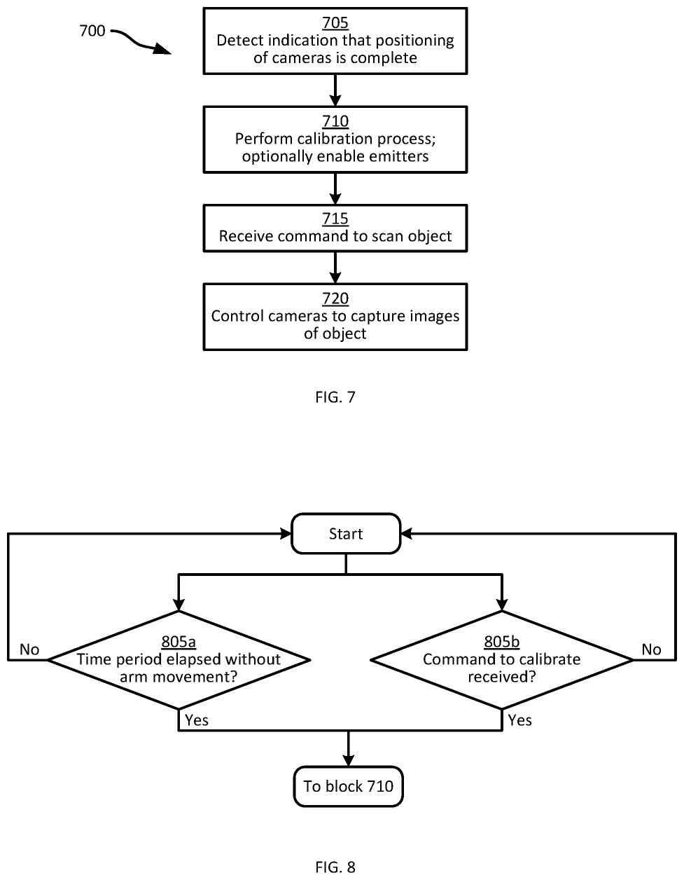

Referring to FIG. 7, a flowchart of a method 700 for scanning an object at the scanner 100 is illustrated. At block 705, the scanner 100, for example via the controller 416 shown in FIG. 4, detects an indication that positioning of the cameras 128 for scanning is complete. At block 710, the scanner 100 (e.g., the controller 416) performs a calibration process, to detect the relative positions of the cameras 128 to each other and to the platform 108. The calibration process of block 710 results in the generation of one or more transforms permitting images captured by each of the cameras 128 to be mapped into a common frame of reference for use in generating a three-dimensional representation of a scanned object. At block 710, the controller 416 can also, in some examples, enable the emitters 604 to project the patterns 608 onto the platform 108.

At block 715, the controller 416 receives a command to scan an object. The command may be received via any of a variety of suitable command mechanisms. For example, the command may be received via a signal communicated to the controller 416 from an external computing device (e.g., a mobile computing device), or via an input assembly on the scanner 100 itself.

In response to the command received at block 715, at block 720 the controller 416 controls at least a subset of the cameras 124, up to and including each of the cameras 124 to capture images (at least one image for each of the above-mentioned subset of the cameras 128) of an object on the platform 108, for use in generating a three-dimensional representation of the object based on the images and the above-mentioned transforms generated at block 710.

Various techniques can be employed to perform the above-mentioned steps of the method 700. Referring to FIG. 8, an example method of performing block 705 of the method 700 is illustrated. In the example of FIG. 8, two alternative mechanisms for implementing the detection of block 705 are shown. At block 805a, the controller 416 determines whether a predefined time period (e.g., five seconds, although other periods greater than 5 seconds or smaller than 5 seconds may also be employed) has elapsed without movement of any arms 132 being detected, e.g., via the sensor 412 mentioned above. When the determination at block 805a is affirmative, the controller 416 proceeds to block 710 as discussed above. When the determination at block 805a is negative, the determination at block 805a or 805b is repeated.

Alternatively, at block 805b the controller 416 determines whether a command to proceed to calibration at block 710 has been received, for example via the input mechanisms mentioned above. When the determination at block 805a is affirmative, the controller 416 proceeds to block 710 as discussed above. When the determination at block 805b is affirmative, the controller 416 proceeds to block 710 as discussed above. When the determination at block 805b is negative, the determination at block 805a or 805b is repeated.

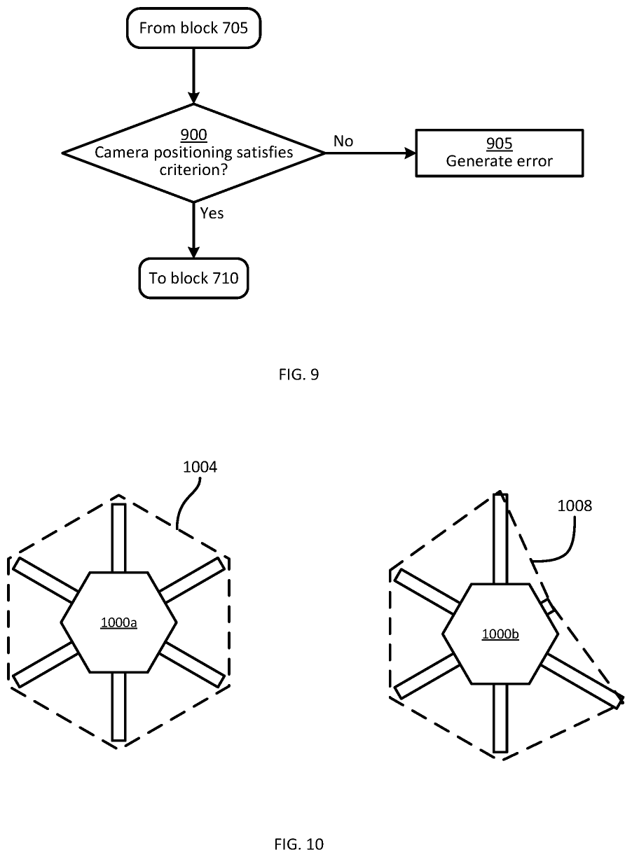

In other examples, referring to FIG. 9, the controller 416 can perform other actions in addition to those shown in FIG. 7. For example, following the performance of block 705, the controller 416 can determine whether the positioning of the cameras 128 satisfies one or more predetermined criteria. An example of such criteria is a geometric criterion. For example, at block 900 (which may be performed between blocks 705 and block 710), the controller 416 can determine the relative positions of the cameras 128, for example by detecting fiducial markers on the platform 108. The controller 416 can then determine whether the positions of the cameras 128 form a convex polygon.

FIG. 10 illustrates a first scanner configuration 1000a in which the arms (and therefore the cameras supported at or near the outer ends of the arms) form a convex polygon 1004. The determination at block 900 is therefore affirmative, and the controller 416 proceeds to block 710.

FIG. 10 also illustrates a second scanner configuration 1000b in which the arms form a concave polygon 1008. In the case of the second configuration 1000b, the determination at block 900 is negative, and the controller 416 proceeds to block 905. At block 905, the controller 416 generates an error message (e.g., a transmission to an associated computing device, an audible or visible signal, or the like).

The provision of a scanner with adjustable arms carrying the cameras 128 as described above enables the scanner to accommodate objects of varying sizes by enlarging the volume of a scan region when necessary to accommodate larger objects, while otherwise employing a smaller scan region, which can reduce the footprint of the scanner 100 and can also increase scanning accuracy.

It should be recognized that features and aspects of the various examples provided above can be combined into further examples that also fall within the scope of the present disclosure. In addition, the figures are not to scale and may have size and shape exaggerated for illustrative purposes.

1. A scanner comprising:
a base defining a platform surface to support an object, the platform surface having a center and a normal axis extending from the center;
a plurality of imaging assemblies, each including (i) a camera mount; and (ii) an arm carrying the camera mount, the arm being movably coupled to the base to place the camera mount at an adjustable distance from the normal axis; and
a plurality of cameras supported by corresponding ones of the camera mounts to define a scan region over the platform surface, the scan region having an adjustable volume according to the distances between the camera mounts and the normal axis.

2. The scanner of claim 1, wherein the camera mounts rotatably support the cameras at adjustable angles relative to the platform surface.

3. The scanner of claim 2, wherein each camera mount adjusts the angle of the corresponding camera in response to movement of the corresponding arm to adjust the distance between the camera mount and the normal axis.

4. The scanner of claim 2, wherein each imaging assembly further comprises a mechanical linkage between the base and the camera mount, to adjust the angle of the corresponding camera responsive to adjustment of the distance between the camera mount and the normal axis.

5. The scanner of claim 1, wherein each imaging assembly includes an emitter to project light onto the platform surface to indicate boundaries for a portion of the scan region.

6. The scanner of claim 1, wherein each arm includes a set of distance indicators on an arm surface.

7. The scanner of claim 1, wherein the arms are independently movable relative to the base.

8. The scanner of claim 1, wherein each imaging assembly includes a sensor to detect movement of the corresponding arm relative to the base.

9. A method comprising:
at a controller of a scanner having adjustably positioned cameras defining an adjustable scan region over a platform surface, detecting an indication that positioning of the cameras for scanning is complete;
responsive to the detection, performing a calibration process at the controller
receive, at the controller, a command to scan an object on the platform surface; and
controlling the cameras to capture images of the object.

10. The method of claim 9, wherein detecting the indication includes receiving a command to perform the calibration process.

11. The method of claim 9, wherein detecting the indication includes detecting that a period of time has elapsed without movement of adjustable arms carrying the cameras.

12. The method of claim 9, further comprising:
in response to completing the calibration, enabling an emitter to project light on the platform surface.

13. The method of claim 9, further comprising:
responsive to the detection, determining whether the positioning of the cameras satisfies a predefined criterion; and
when the positioning of the cameras does not satisfy the predefined criterion, generating an error message.

14. The method of claim 13, wherein the predefined criterion is that positions of the cameras form a convex polygon.

15. A scanner comprising:
a platform to support an object to be scanned;
a plurality of cameras supported at adjustable positions about a perimeter of the platform to define a scan region having an adjustable volume according to the positions of the cameras; and
a controller connected with the cameras to:
generate calibration data defining the relative positions of the cameras;
control the cameras to capture a set of images of the object; and
generate a three-dimensional representation of the object based on the set of images and the calibration data.
